(19) United States
(12) Patent Application Publication
(10) Pub. No.: US 2019/0218150 A1
(43) Pub. Date: Jul. 18, 2019

(54) METHOD OF PRODUCING A CERAMIC FIRED BODY

(71) Applicant: NGK INSULATORS, LTD., Nagoya-Shi (JP)

(72) Inventors: Chikashi IHARA, Nagoya-Shi (JP); Shinya YOSHIDA, Nagoya-Shi (JP); Yoshiyuki KAMEI, Nagoya-Shi (JP); Masato SHIMADA, Nagoya-Shi (JP)

(73) Assignee: NGK INSULATORS, LTD., Nagoya-Shi (JP)

(21) Appl. No.: 16/231,652

(22) Filed: Dec. 24, 2018

(30) Foreign Application Priority Data
Jan. 17, 2018 (JP) 2018-005846

(51) Int. Cl. C04B 41/00; C04B 14/04; C04B 41/50

(52) U.S. Cl. CPC C04B 41/009; C04B 35/64; C04B 41/5076; C04B 14/04

(57) ABSTRACT

A method of producing a ceramic fired body may includes a step of passing a first accommodating shelf through a firing kiln, the first accommodating shelf including a stack of units of a shelf plate and a frame placed on the shelf plate, one or more ceramic bodies placed on the shelf plate being surrounded by the frame extending in a circumferential direction between the shelf plates; a step of retrieving one or more frames from the first accommodating shelf which has passed through the firing kiln; a step of using the one or more retrieved frames to build a second accommodating shelf for passing through the firing kiln; and a step of rotating the retrieved frame such that a rotational position of the retrieved frame when the second accommodating shelf passes through the firing kiln is different from a rotational position of the retrieved frame when the first accommodating shelf passed through the firing kiln.

### CROSS-REFERENCE TO RELATED APPLICATION

The present application claims a priority of Japanese Patent Application No. 2018-5846, filed on Jan. 17, 2018 and entitled “A method of producing a ceramic fired body”, the entire content of which is hereby incorporated by reference.

### TECHNICAL FIELD

The present disclosure is related to a method of producing a ceramic fired body.

### BACKGROUND

Japanese Patent Application Laid-open No. H09-188580 (A) discloses in its FIG. 2 that a combination of shelf plates and pillars is used for firing.

### SUMMARY

As the number of times the frame passing through a firing kiln increases, deformation can be accumulated in a frame in some cases.

A method of producing a ceramic fired body according to an aspect of the present disclosure may include:

a step of passing a first accommodating shelf through a firing kiln, the first accommodating shelf including a stack of units of a shelf plate and a frame placed on the shelf plate, one or more ceramic bodies placed on the shelf plate being surrounded by the frame extending in a circumferential direction between the shelf plates;

a step of retrieving one or more frames from the first accommodating shelf which has passed through the firing kiln;

a step of using the one or more retrieved frames to build a second accommodating shelf for passing through the firing kiln; and

a step of rotating the retrieved frame such that a rotational position of the retrieved frame when the second accommodating shelf passes through the firing kiln is different from a rotational position of the retrieved frame when the first accommodating shelf passed through the firing kiln.

In some cases, the retrieved frame is rotated about a rotational axis that matches a vertical direction in accordance with increase of the number of times the retrieved frame passes through the firing kiln.

In some cases, the retrieved frame may be rotated at a predefined constant angle.

In some cases, the frame may include silicon carbide (SiC) or alumina (Al₂ O₃) or mullite (3Al₂ O₃ 2SiO₂).

In some cases, the frame may be square-shaped.

In some cases, the rotation of the retrieved frame may be performed,

when the frame is retrieved from the first accommodating shelf which has passed through the firing kiln; and/or

when the second accommodating shelf is built; and/or

when the frame is transferred from one location to another location.

In some cases, the rotation of the retrieved frame may be performed based on operation of a transferring mechanism that transfers the frame.

In some cases, the transferring mechanism may include a chuck configured to hold the frame.

In some cases, the one or more ceramic bodies to be fired in the firing kiln may include one or more debindered ceramic bodies.

In some cases, said building a second accommodating shelf using one or more retrieved frames may include placing the retrieved frame onto the shelf plate on which the debindered ceramic bodies are placed.

In some cases, the rotation of the retrieved frame may be caused by at least one of:

(i) rotation of the shelf plate on which the retrieved frame is placed;

(ii) rotation of the second accommodating shelf; and

(iii) rotation of the retrieved frame.

In some cases, the shelf plate may be provided with at least one protrusion such that the position of the frame is restricted on the shelf plate.

In some cases, the ceramic body may include at least silicon carbide (SiC).

In some cases, the ceramic body may have a lattice-like cell-wall defining a plurality of cells.

In some cases, firing the one or more ceramic bodies in the firing kiln may be performed under nonoxidative atmosphere.

According to an aspect of the present disclosure, it would be possible to reduce a magnitude of deformation which may otherwise be accumulated in a frame in accordance with increase of the number of times the frame passes through a firing kiln.

### BRIEF DESCRIPTION OF DRAWINGS

Hereinafter, non-limiting embodiments of the present disclosure will be described with reference to FIGS. 1 to 13 in which like parts are identified by the same numbers. A skilled person would be able to combine respective embodiments and/or respective features without requiring excess descriptions, and would appreciate synergistic effects of such combinations. Overlapping descriptions among the embodiments would be basically omitted. Referenced drawings are prepared for the purpose of illustration of invention, and might possibly be simplified for the sake of convenience of illustration.

FIG. 1 is a schematic illustration of production line and production method of ceramic fired bodies according to an aspect of the present disclosure. An accommodating shelf for passing through a debindering kiln moves between a first location P1 and a second location P2. Frames retrieved from the accommodating shelf having passed through the debindering kiln moves between the second location P2 and the first location P1. Frames retrieved from an accommodating shelf which has passed through a firing kiln moves between a fourth location P4 and the third location P3. The accommodating shelf moves from the third location P3 to the fourth location P4 to pass through the firing kiln. Roller conveyor or belt conveyor may be used for transferring the accommodating shelf and the frames.

FIG. 2 is a schematic view illustrating that an accommodating shelf according to an aspect of the present disclosure passes through a firing kiln, the accommodating shelf accommodating a plurality of ceramic bodies. In a case where obstacles are formed inside of the firing kiln, an undesired contact between the obstacle and the accommodating shelf may happen.

FIG. 3 is schematic perspective view of an accommodating shelf according to an aspect of the present disclosure. Illustration of middle portion between top and bottom portions of the accommodating shelf is omitted.

FIG. 4 is a schematic cross-sectional view illustrating that, in the accommodating shelf according to an aspect of the present disclosure, a protrusion is provided on a top surface of the shelf plate that restricts the position of the frame.

FIG. 5 is a schematic perspective view of a ceramic body according to an aspect of the present disclosure.

FIG. 6 is a schematic cross-sectional view of a ceramic body taken along a plane PL7 shown by double-dot chain line in FIG. 5.

FIG. 7 is a schematic perspective view of a filter including a plurality of ceramic fired bodies according to an aspect of the present disclosure.

FIG. 8 is a schematic flowchart regarding a method of producing ceramic fired bodies.

FIG. 9 is a schematic view illustrating a mechanism for and a method of retrieving frames from an accommodating shelf which has passed through a firing kiln, and building a stack of frames by stacking them. In some cases, the frame may be rotated based on operation of a transferring mechanism for transferring the frame.

FIG. 10 is a schematic view illustrating a mechanism for and a method of retrieving, from an accommodating shelf which has passed through a debindering kiln, a shelf plate having a top surface on which ceramic bodies are placed, and using the retrieved shelf plate to build a new accommodating shelf which is designed to pass through the firing kiln.

FIG. 11 is a schematic view illustrating a mechanism for and a method of retrieving a frame from a stack of frames, and using the retrieved frame to build a new accommodating shelf which is designed to pass through the firing kiln. In some cases, the frame may be rotated based on operation of a transferring mechanism for transferring the frame.

FIG. 12 is a schematic view illustrating that a rotational position of the frame when passes through a firing kiln is changed according to increase of number of times the frame passes through the firing kiln.

FIG. 13 is a schematic view illustrating deformation of a frame.

### DETAILED DESCRIPTION

In the following descriptions, a plurality of features described for a method of producing would be understood as individual features independent to other features, additionally to as combination with other features. The respective features would be understood as individual features without requiring combination with other features, but could be understood as combination with one or more another or other features. Describing all combinations of individual features would be redundant for a skilled person, and thus omitted. The individual features would be identified by a language of “In some cases”. The individual features would be understood as a universal feature that is effective not only to a method of producing disclosed in the present application, but also effective to other various methods of producing not particularly described in the present specification.

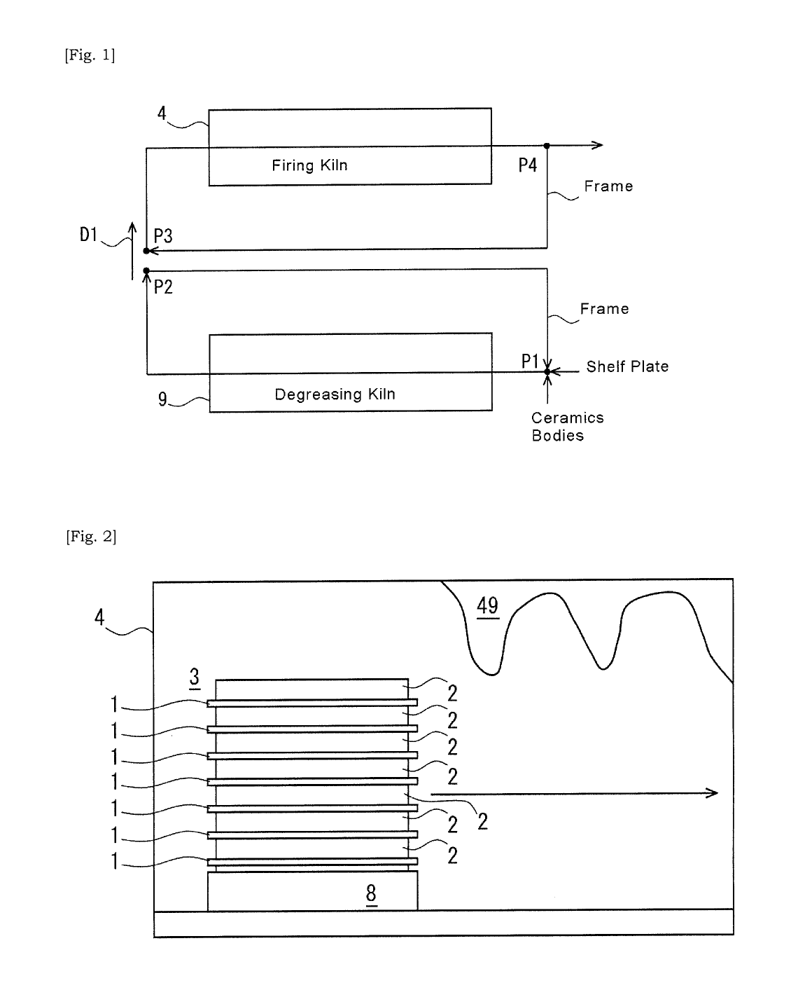

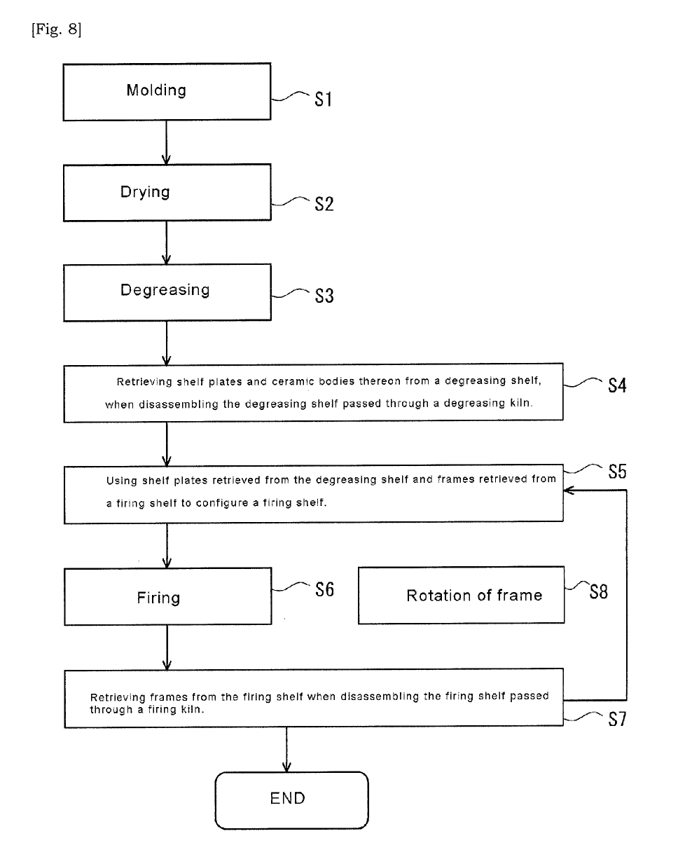

In a production line and method of ceramic fired bodies of the present disclosure such as shown in FIG. 1, ceramic bodies 7 shown in FIGS. 3, 5 and 6 may be debindered and next fired. As shown in FIGS. 1 and 8, the ceramic bodies 7 may be debindered in a debindering kiln 9 (S3), and next fired in a firing kiln 4 (S6). It should be noted that it is envisioned that debindering and firing would be performed successively in the firing kiln 4, omitting the debindering kiln 9. In the debindering kiln 9, the ceramic bodies 7 are heated, and an organic binder included in the ceramic body 7 is removed. In the firing kiln 4, debindered ceramic bodies 7 are fired, and ceramic material, e.g. particles of silicon carbide (SiC) are coupled. Heating of the ceramic bodies 7 in the debindering kiln 9 is performed under oxidative atmosphere, e.g. air atmosphere, not necessarily limited to this through. Firing of the ceramic bodies 7 in the firing kiln 4 is performed under nonoxidative atmosphere, e.g. inert gas atmosphere such as Argon. Oven temperature in the debindering kiln 9 during a step of debindering the ceramic bodies 7 may be equal to or less than 500° C. Kiln temperature in the firing kiln 4 during a step of firing the ceramic bodies 7 may be equal to or over 1000° C. The debindering kiln 9 may be referred to as a first firing kiln, and the firing kiln 4 may be referred to as a second firing kiln. Again, omission of the debindering kiln 9 is envisioned.

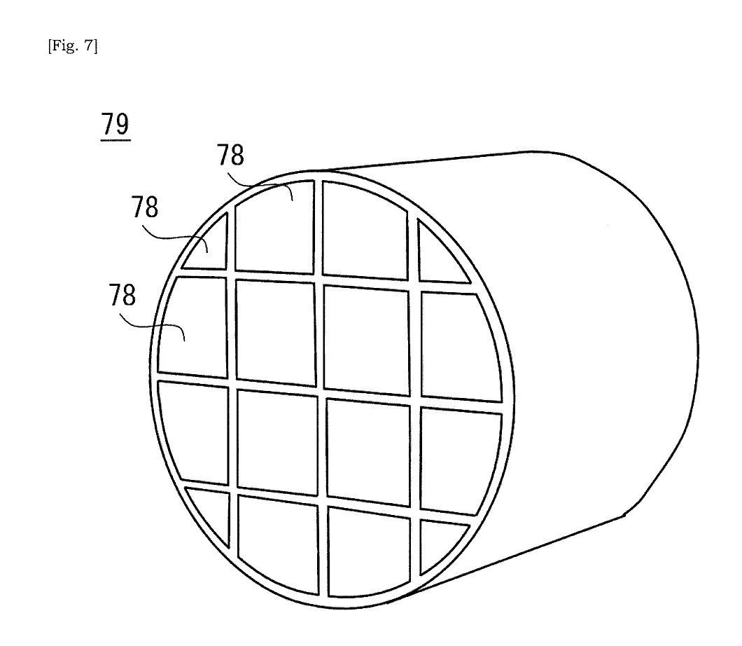

The debindered and fired ceramic bodies 7 may be used to produce a filter 7 shown in FIG. 7. A filter 79 shown in FIG. 7 is a functional part for collecting and removing particles, i.e. PM (Particulate Matter) included in an exhaust gas exhausted from an internal combustion engine such as a diesel engine. The filter 79 is produced by two-dimensionally arranging the ceramic fired bodies 78 using adhesive, shaping this obtained block into a cylinder shape, and finally coating the outer circumferential surface of the cylinder with an outer circumferential layer and firing it. It should be noted that the filter 79 can be used in other various applications such as purification of polluted water and the like, not limited to purification of exhaust gas from a diesel engine. It is envisioned that various types of catalyst are introduced into the ceramic body 7 included in the filter 79. An adhesive layer and/or the outer circumferential layer of the filter 79 may include cordierite (2MgO2Al₂ O₃ 5SiO₂) in some cases.

The ceramic body 7 shown in FIGS. 3, 5 and 6 may be one that has been produced through molding (S1) and drying (S2) of raw material, as would be understood from FIG. 8. In some cases, the raw material includes at least a clay, or at least ceramic material, organic binder and water. The ceramic material may include at least one material selected from a group consisting of: a raw material that will be cordierite (2MgO.2Al₂ O₃.5SiO₂) through firing, silicon carbide (SiC), mullite (3Al₂ O₃ 2SiO₂), alumina (Al₂ O₃), and zirconia (ZrO₂). The organic binder may include at least one material selected from a group consisting of agar, hydroxypropylmethylcellulose, hydroxyethylcellulose, carboxymethylcellulose, methylcellulose, polyvinyl alcohol, and starch. An extruder is used to extrude a ceramic body 7, and this is next dried by a drying apparatus. Accordingly, a ceramic body 7 is produced which has a sufficient hardness allowing a human hand or a machine to grip.

The raw material that will be cordierite (2MgO.2Al₂ O₃.5SiO₂) through firing can be referred to as a cordierite precursor. The cordierite precursor raw material has a chemical composition which includes 40-60 mass % of silica, 15-45 mass % of alumina, and 5-30 mass % of magnesia. The cordierite precursor raw material may be a mixture of plural inorganic raw materials selected from a group consisting of talc, kaolin, calcined kaolin, alumina, aluminum hydroxide, and silica. When a ceramic molded body includes a cordierite precursor raw material, a firing temperature may be set between 1380-1450° C. or 1400-1440° C. A time period of firing may be 3-10 hours.

the ceramic body 7 has a lattice-like cell-wall 72 that defines a plurality of cells 71, not necessarily limited to this through. Open shape of each cell 71 defined by the lattice structure in the ceramic body 7 may be a polygon or a circle or an oval. Polygon may be triangle, rectangle, pentagon, hexagon or others. The ceramic body 7 has a first end 76 and a second end 77, and extends between the respective ends 76, 77. The cell 71 extends along an extending direction of the ceramic body 7.

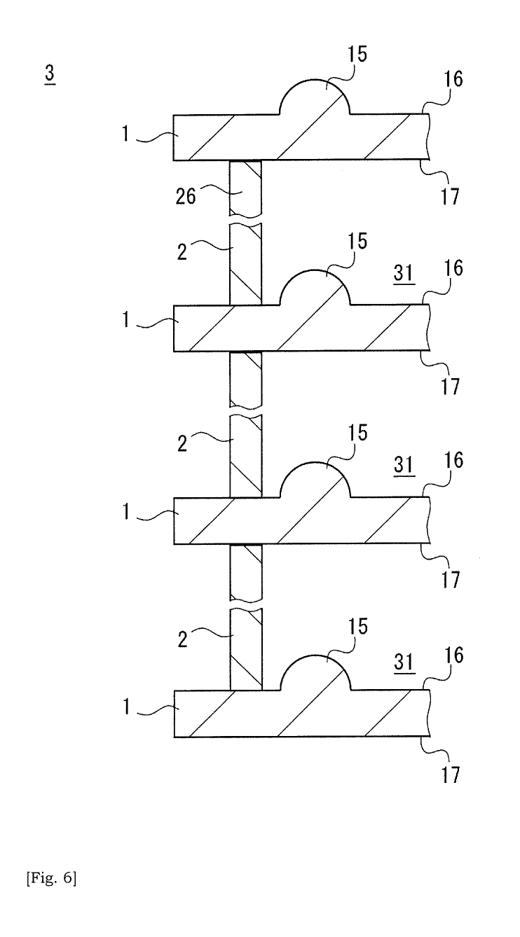

Some cells 71 in the two-dimensional arrangement of cells 71 are sealed by sealants 73, not necessarily limited to this through. As shown in FIG. 6, a sealed pattern of the cells 71 by the sealants 73 at the first end 76 of the ceramic body 7 may be complimentary with a sealed pattern of the cells 71 the sealants 73 at the second end 77 of the ceramic body 7. Balancing of permeability of exhaust gas and ability to purify exhaust gas in the filter 79 may be facilitated. It should be noted that the first end 76 may be an end arranged closer to an engine in a flow direction of exhaust gas, and the second end 77 may be an end that is arranged farther away from the engine in the direction of exhaust gas.

In some cases, the ceramic body 7 includes at least silicon carbide (SiC). In some cases, the ceramic body 7 is not debindered, and has an organic binder additionally to silicon carbide. In some cases, the ceramic body 7 is debindered, and has a carbon residue component additionally to silicon carbide. The carbon residue component may be carbon that originates from the organic binder. Ceramic material included in the ceramic body 7 should not be limited to silicon carbide, but could be other ceramic material such as a cordierite.

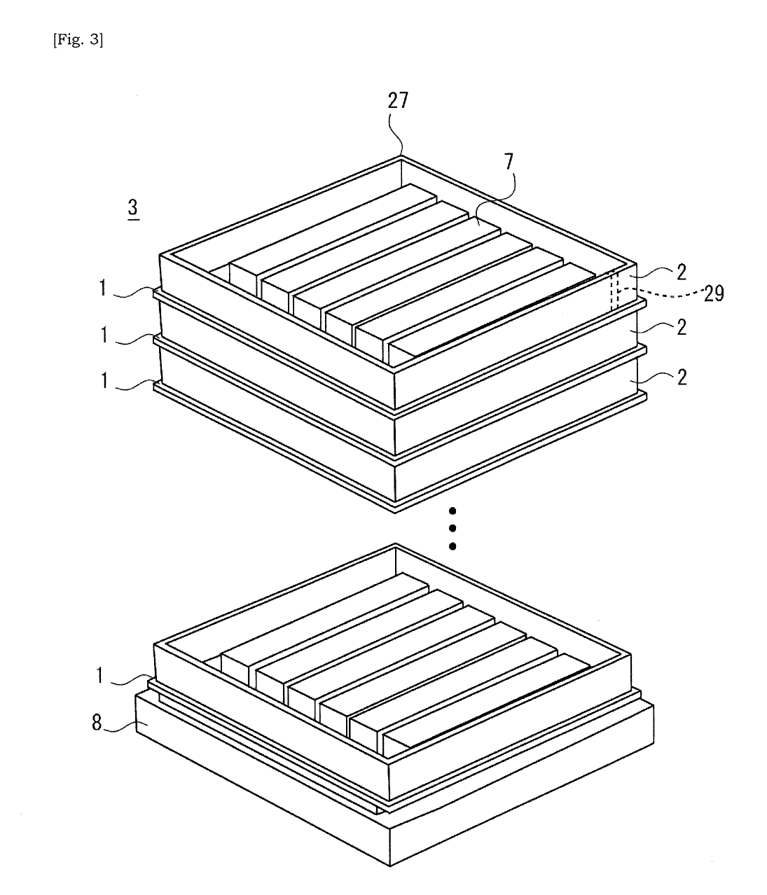

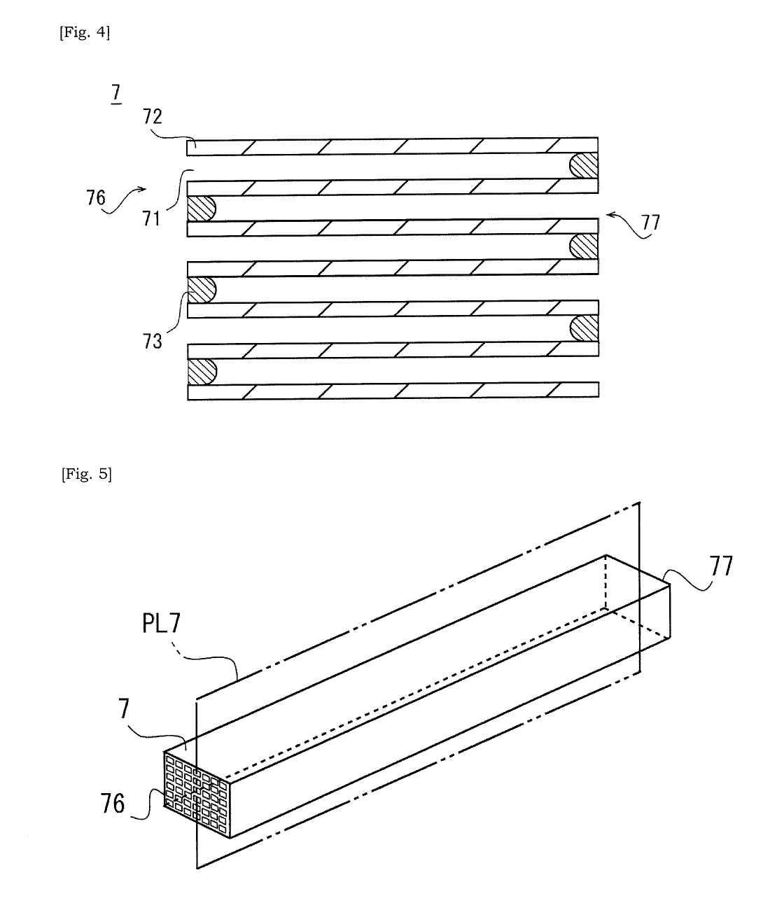

A number of ceramic bodies 7, while being accommodated in an accommodating shelf 3 shown in FIGS. 2-4, passes through a debindering kiln 9 and/or a firing kiln 4. The number of ceramic bodies 7 accommodated in the accommodating shelf 3 depends on a size of shelf plate 1, the number of shelf plates 1 included in the accommodating shelf 3, and a size of ceramic body 7 itself. The accommodating shelf 3 moves in a predefined direction in the debindering kiln 9 and/or the firing kiln 4. A moving speed of the accommodating shelf 3 would be appropriately set, thus defining a time period of existence of the accommodating shelf 3 within the kiln, i.e. debindering or firing time period within a kiln. Temperature profile at each kiln would be appropriately set in light of object of each kiln. The temperature profile at each kiln may indicate a change of kiln temperature along a time axis. In some cases, the accommodating shelf 3 is placed on a kiln car 8, and moves within a kiln while the kiln car 8 is pushed by pushing means (not-illustrated). It is also envisioned that the kiln car 8 runs by itself. If required, various types of conveyors such a roller conveyor or a belt conveyor would be employed for driving the accommodating shelf 3.

The accommodating shelf 3 includes a plurality of units of a shelf plate 1 and a frame 2 placed on the shelf plate 1, i.e. is built by stacking units of the shelf plate 1 and frame 2. One or more ceramic bodies 7 placed on the shelf plate 1 are surrounded by the frame 2 extending in a circumferential direction between the shelf plates 1. In particular, the accommodating shelf 3 is built by alternate stacking of the shelf plate 1 and the frame 2 along a vertical direction. The shelf plate 1 is arranged in a plane perpendicular to the vertical direction. The frame 2 extends in the circumferential direction with respect to or centered around a given axis parallel to the vertical direction. The frame 2 is placed between shelf plates 1 adjacent in the vertical direction, defining an accommodating space 31 for the ceramic bodies 7. In some cases, the accommodating space 31 is separated from a kiln atmosphere as being closed by the shelf plates 1 and the frame 2, or is spatially communicated to a kiln atmosphere through one or more openings formed in the shelf plate 1 and/or the frame 2. It may be understood that the separation of the accommodating space 31 from the kiln atmosphere does not indicate a complete separation of the accommodating space 31 from the kiln atmosphere, but indicates a state in which fluid-communication is hindered between the kiln atmosphere and the accommodating space 31.

The shelf plate 1 has a top surface 16 on which the ceramic bodies 7 are placed, and a bottom surface 17 that is opposite to the top surface 16. Gravel of appropriate refractory material may be dispersed on the top surface 16 of the shelf plate 1 so as to avoid or suppress that the shelf plate 1 and the ceramic bodies 7 are bonded while being fired in the firing kiln 4. The frame 2 has a circumferential wall 26 that extends in a circumferential direction with respect to or centered around a given axis parallel to the vertical direction. The circumferential wall 26 is continuous or discontinuous in the circumferential direction. In a case where the circumferential wall 26 is continuous in the circumferential direction, the frame 2 is a closed frame. In a case where the circumferential wall 26 is discontinuous in the circumferential direction, the frame 2 is an open frame. The open frame in which the circumferential wall 26 is discontinuous in the circumferential direction is, for example, one shown in FIG. 3 where a portion of the circumferential wall 26 indicated by a reference number 29 is removed. In some cases, the frame 2 is polygon-shaped and/or the circumferential wall 26 defines a polygon-like opening. A cross-sectional shape of the frame 2 in a plane perpendicular to the vertical direction may be rectangular. The circumferential wall 26 may be provided with plural corners 27. If the frame 2 is shaped like a rectangle, the circumferential wall 26 is provided with four corners 27.

The shelf plate 1 and the frame 2 may be made of refractory material. The shelf plate 1 and/or the frame 2 includes silicon carbide (SiC) or alumina (Al₂ O₃) or mullite (3Al₂ O₃ 2SiO₂) or is a sintered body of silicon carbide (SiC) or alumina (Al₂ O₃) or mullite (3Al₂ O₃ 2SiO₂), not necessarily limited to this through. The silicon carbide (SiC) included in the shelf plate 1 and/or the frame 2 may include at least one of or any combination of reaction-bonded Si/SiC, recrystallized SiC (Re—SiC), and nitride-bonded SiC (N—SiC). In particular, in some cases, the frame 2 includes alumina (Al₂ O₃) or mullite (3Al₂ O₃.2SiO₂) or is made of alumina (Al₂O₃) or mullite (3Al₂ O₃.2SiO₂). In a case where the frame 2 is made of alumina or mullite as an alternative to silicon carbide, decrease of weight of frame 2 in accordance with increase of the number of times the frame 2 passes through the firing kiln 4 would be moderate, possibly resulting in longer lifetime of the frame 2. However, in contrast, deformation of the frame 2 in accordance with increase of the number the frame 2 passes through the firing kiln 4 may be greater.

The shelf plates 1 and the frames 2 are expected to repeatedly pass through the firing kiln 4, and they are requested or desired to have a fire-resistance sufficient to endure repeated exposures to higher temperature. The firing kiln 4 may have a temperature in kiln that exceeds 1000° C. when the ceramic bodies 7 are fired. As a result of being exposed to such high temperature, the shelf plate 1 or the frame 2 degrade in accordance with increase of number of times they passes through the firing kiln 4, e.g. their weight may be reduced. The number of times the shelf plate 1 or the frame 2 passes through the firing kiln 4 could be understood as the number of usage of the shelf plate 1 or the frame 2. Reduction of weight of the shelf plate 1 or the frame 2 may be accompanied by generation of obstacles 49 of ceramic material in the firing kiln 4. The obstacles 49 of ceramic material may include a pillar grown downward in the vertical direction or in any direction that crosses the vertical direction. Contacts are afraid between the accommodating shelf 3 moving within the firing kiln 4 and the obstacles 49 within the kiln. In some cases, in order to avoid or suppress this difficulty, at least one protrusion 15 is provided on the shelf plate so that the position of the frame 2 on the shelf plate 1 is restricted. That is, it is avoided or suppressed that the accommodating shelf 3 is partially or totally collapsed due to a slight contact between the obstacle 49 and the accommodating shelf 3.

The protrusion 15 provided on the shelf plate 1 may be positioned inwardly and/or outwardly of the frame 2 when the frame 2 is placed on the shelf plate 1. The protrusion 15 may be provided on one side or both sides of the shelf plate 1, i.e. on the top surface 16 and/or the bottom surface 17. In some cases, the protrusion 15 may be positioned corresponding to a corner 27 of the circumferential wall 26 and/or may be positioned inwardly of the corner 27 of the circumferential wall 26. For example, four protrusions 15 are positioned corresponding to four corners 27 of the circumferential wall 26. Each protrusion 15 may include first and second extending portions that extends along the circumferential wall 26, and the first and second extending portions may cross or may be orthogonalized.

Again, the frames 2 are requested or desired to have a fire-resistance sufficient to endure repeated passing though the firing kiln 4. Analysis by the present inventors has revealed that deformation of the frame 2 accumulated in accordance with repeated use of the frame 2 would shorten a lifetime of the frame 2, and may additionally invites at least one of the following disadvantages (i)-(iii). As a result of deformation of the frame 2, (i) stability or closed state of atmosphere in the accommodating space 31 is lowered, in turn causing inferior firing of the ceramic body 7; (ii) a balance of the accommodating shelf 3 moving in the firing kiln 4 is deteriorated, thus increasing a change of contact between the obstacles 49 and the accommodating shelf 3 moving in the firing kiln 4; and (iii) in a case where the protrusion 15 is provided on the shelf plate 1, the frame 2 may contact the protrusion 15, lowering stability or closed state of atmosphere in the accommodating space 31. The above-described items (i)-(iii) may reduce a yield and/or quality of ceramic fired bodies 78.

In particular, in some cases, the frame 2 includes ceramic material other than silicon carbide or is made of ceramic material other than silicon carbide. In this case, compared with a case where the frame 2 is made of silicon carbide, a magnitude of deformation of the frame 2 in accordance with increase of the number of times the frame 2 passes through the firing kiln 4 may be greater. Ceramic material other than silicon carbide may be alumina (Al₂ O₃) or mullite (3Al₂ O₃. 2SiO₂) in some cases, but should not be limited to this and could be other low-heat-conductivity ceramics. Note that in a case where alumina or mulita frame 2 is used, it has been proved that target color or strength of ceramic fired bodies cannot be obtained as a result of the above-described item (i).

As would be more concretely understood from the following descriptions, a method of producing a ceramic fired body according to the present disclosure includes:

a step of passing an accommodating shelf 3 through a firing kiln 4,

a step of retrieving a frame 2 from the accommodating shelf 3 which has passed through the firing kiln 4;

a step of using the retrieved frame 2 to build a new accommodating shelf 3 for passing through the firing kiln 4; and

a step of rotating the retrieved frame 2 such that a rotational position of the retrieved frame 2 included in the new accommodating shelf 3 when passing through the firing kiln 4 is different from a rotational position of the retrieved frame 2 when it passed through the firing kiln 4.

Due to the rotation of the frame 2, deformation of the frame 2 caused in a past step of firing would be facilitated to be cancelled by deformation of the frame 2 which will be caused in the following or future step of firing. Accordingly, an amount of deformation of the frame 2 in accordance with increase of the number of times the frame 2 passes through the firing kiln 4 can be lowered, and thus facilitating longer lifetime of the frame 2.

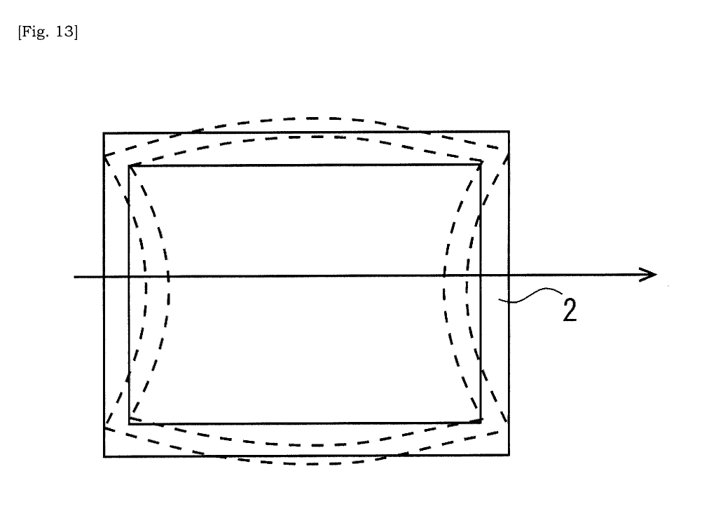

Deformation of the frame 2 may be dependent to the shape of the frame 2, the thickness of the circumferential wall of the frame 2, or the material of the frame 2. Additionally or alternatively, deformation caused in the frame 2 may be dependent to a temperature profile in the firing kiln 4 or temperature distribution that may be caused within the firing kiln 4. The temperature profile in the firing kiln 4 indicates a temperature change in the firing kiln 4 along an axis of time. When the accommodating space 31 is closed by the shelf plate 1 and the frame 2, due to insulation by the frame 2 and/or sensible heat of the ceramic body 7 within the accommodating space 31, a temperature difference is caused between the kiln atmosphere and the accommodating space 31, i.e. the temperature of the accommodating space 31 becomes lower than the temperature of the kiln atmosphere. According to this difference, temperature gradient is caused between the outer peripheral surface and inner peripheral surface of the circumferential wall 26, and the circumferential wall 26 may be deformed so as to be curved inwardly or outwardly. FIG. 13 schematically illustrates that an arrow indicates a moving direction of the accommodating shelf 3 within a kiln, and a portion of the circumferential wall 26 parallel to the arrow is outwardly curved, resulting in that a portion of the circumferential wall 26 perpendicular to the moving direction is inwardly curbed. FIG. 13 expresses a deformation of the frame 2, in one sense, excessively for easier recognition, and we do not see that deformation of such an extent shown in FIG. 13 would be caused in the frame 2. When the frame 2 is shaped like a rectangle, not a square, deformation such as shown in FIG. 13 may be induced. Therefore, in some cases, the frame 2 is square-shaped.

Hereinafter, more concrete description will be followed on a method of producing a ceramic fired body 78 with reference to FIGS. 1, and 8-12. It should be noted that an accommodating shelf 3 that passes through the debindering kiln 9 may be referred to as a debindering shelf 3e, and that an accommodating shelf 3 that passes through the firing kiln 4 may be referred to as a firing shelf 3f. Likewise, a frame 2 included in the debindering shelf 3e may be referred to as a debindering frame 2e, and a frame 2 included in the firing shelf 3f may be referred to as a firing frame 2f. In some cases, debindering in the debindering kiln 9 is performed under air atmosphere, and therefore the debindering frame 2e is provided with one or more openings that are in communication between the inside and the outside of the frame. Additionally, firing in the firing kiln 4 is performed under an inert gas atmosphere, e.g. argon atmosphere, and the firing frame 2f is configured to close the accommodating space 31 together with the shelf plates 1. In this case, the ceramic body 7 may include silicon carbide (SiC) that will be bonded under non-oxidation atmosphere. The debindering frame 2e may have a lower heat-resistance than the firing frame 2f. In some cases, the debindering frame 2e includes silicon carbide, and the firing frame 2f includes alumina or mullite. It should be noted that metal frames can be used as the debindering frames 2e. A case is envisaged where an opening is formed in the firing frame 2f.

At the first location P1 in FIG. 1, the accommodating shelf 3, i.e. debindering shelf 3e is built. More concretely, ceramic bodies 7 produced through molding (S1) and drying (S2) of raw material are placed on the shelf plate 1. A debindering frame 2e is placed on the shelf plate 1. Placing the ceramic bodies 7 on the shelf plate 1 and placing the debindering frame 2e on the shelf plate 1 are repeated so that a debindering shelf 3e is built. Greater the number of ceramic bodies 7 accommodated in the debindering shelf 3e, higher the efficiency of producing the ceramic bodies 7. However, there is certainly a restraint on the internal space size of the debindering kiln 9 and the like.

The debindering shelf 3e may arbitrarily move within the debindering kiln 9 (S3). As being exposed to higher temperature in the debindering kiln 9, organic binder in the ceramic bodies 7 within the debindering shelf 3e is removed through oxidization and burning. Carbon originated from organic binder may remain in the debindered ceramic body 7.

At the second location P2 in FIG. 1, the debindering shelf 3e is disassembled, and the shelf plate 1 on which the debindered ceramic bodies 7 are placed is retrieved from the debindering shelf 3e (S4). The shelf plate 1 on which the debindered ceramic bodies 7 are placed is used for the firing shelf 3f that is designed to pass through the firing kiln 4. The debindering frame 2e retrieved from the debindering shelf 3e is returned from the second location P2 to the first location P1 as shown in an arrow in FIG. 1, and will be used for another debindering shelf 3e.

At the third location P3 in FIG. 1, an accommodating shelf 3 that is designed to pass through the firing kiln 4, i.e. firing shelf 3f is built. More concretely, a firing shelf 3f is built using a shelf plate 1 retrieved from the debindering shelf 3e and a firing frame 2f retrieved from a firing shelf 3f disassembled at the fourth location P4 (S5). An accommodating shelf 3 from which the firing frame 2f is retrieved may be referred to as a previous accommodating shelf 3, and an accommodating shelf 3 newly built by using this retrieved firing frame 2f may be referred to as a current accommodating shelf 3. The previous accommodating shelf 3 and the current accommodating shelf 3 are not limited to ones which are continuously thrown into the firing kiln 4 in terms of time.

The current firing shelf 3f passes through the firing kiln 4 (S6). As being exposed to higher temperature in the firing kiln 4, ceramic material of the ceramic body 7 in the firing shelf 3f will bond. In a case where the ceramic body 7 includes silicon carbide, particles of silicon carbide will bond. The ceramic fired body 78 is porous. Adjacent cells 71 are in spatial communication via micro-holes in the cell-wall 72.

At the fourth location P4 in FIG. 1, a firing shelf 3f having passed through the firing kiln 4 is disassembled. More concretely, the shelf plates 1 and the firing frames 2f are retrieved from the firing shelf 3f (S7). At the same time, the ceramic fired bodies 7 on the shelf plate 1 are retrieved. Retrieving the shelf plates 1 or the firing frames 2f from the firing shelf 3f may be performed by a worker hand.

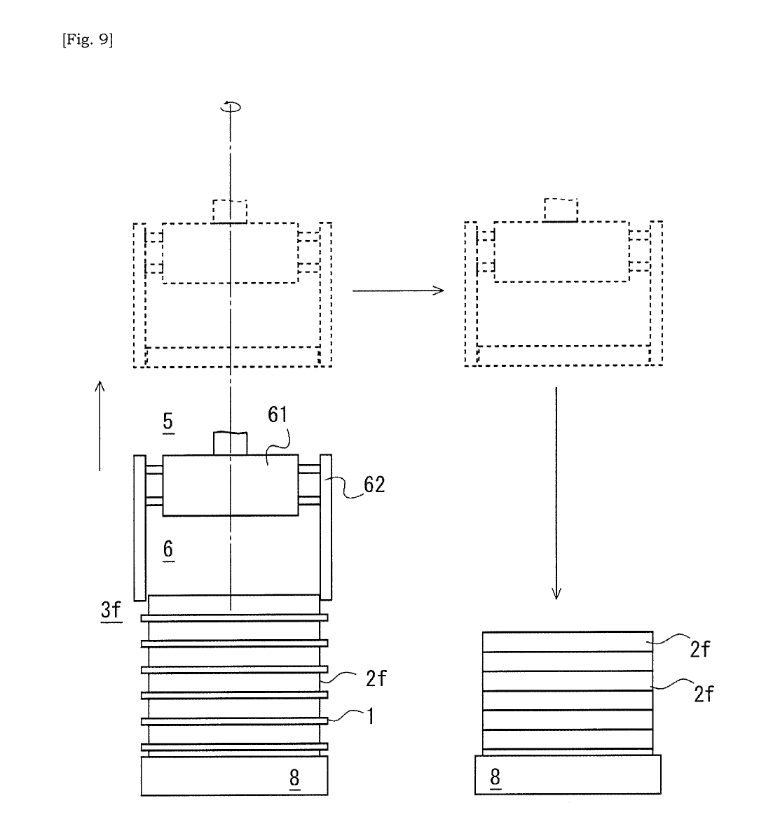

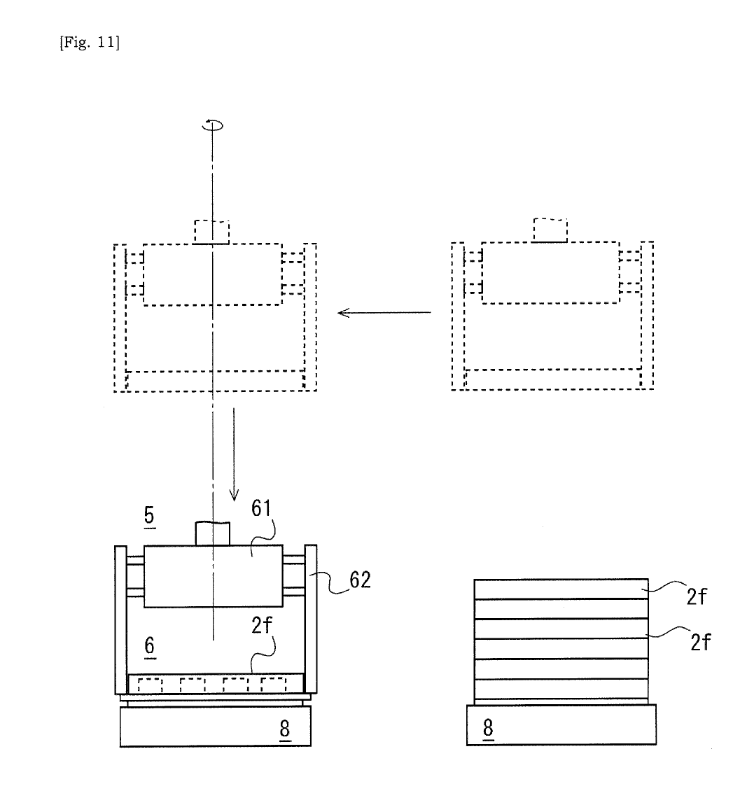

Rotating the firing frame 2f (S8) would be done variously in manner, means and time. Rotating the frame 2 may be performed when the frame 2 is retrieved from the accommodating shelf 3 that has passed the firing kiln 4 (in a case of FIG. 9); and/or when the new accommodating shelf 3 is built (in a case of FIG. 11), and/or when the frame 2 is transferred from one location to another location (in cases of FIGS. 9 and 11 or any other cases). The above-described rotation of the frame 2 may be performed by worker hand or machinery. In some cases such as shown in FIGS. 9-11, a transferring mechanism 5 for transferring the shelf plate 1 and/or the frame 2 rotates the frame 2. That is, rotation of the frame 2 is caused based on operation of the transferring mechanism 5.

Rotation of the frame 2 may be caused by rotating the frame 2 itself, or rotating the shelf plate 1 on which the frame 2 is placed, or rotating the accommodating shelf 3 including the frame 2. In view of this aspect, a skilled person would understand that the frame 2 can be rotated at any suitable timing and by any suitable means.

FIG. 9 illustrates that, based on operation of a transferring mechanism 5 at the fourth location P4, stacked are the firing frames 2f retrieved from the accommodating shelf 3 having passed the firing kiln 4. Again, it is envisioned that, at the fourth location P4, a worker, i.e. human may disassemble the accommodating shelf 3. The transferring mechanism 5 can transfer the frame 2 from one location to another location and can rotate, while transferring, the frame 2. Specific structure of the transferring mechanism 5 would be various and should not be limited to the disclosed example. In some cases including illustrated examples, the transferring mechanism 5 has a chuck 6 configured to hold the firing frame 2f. The chuck 6 has a body 61 and a pair of arms 62 arranged to be movable relative to the body 61. A spacing between the paired arms 62 is appropriately controlled so that the chuck 6 grasps the firing frame 2f. For example, the arm 62 is coupled to the body 61 via a cylinder, and the spacing between the body 61 and the arm 62 is determined based on the expansion or contraction of the cylinder. A terminal end of the arm 62 is provided with a non-illustrated elastic member, and soft contact is secured between the frame and the arm.

In some cases, chuck 6 is attached to a terminal end of a multi-articulated robot arm and is rotatable at the terminal end. The robot arm may be one sold in a market. In another case, the chuck 6 is mounted, via a cylinder, to a carrier capable of running on a rail, and is rotatable at the terminal end of the cylinder. Additionally or alternatively, the cylinder is rotatable relative to the carrier. It should be noted that the chuck 6 may have at least two multi-articulated robot arms as a replacement to the exemplary structure of above-described body 61 and arm 62. The firing frame 2f is grasped between these robot arms. It would be apparent for a skilled person that the chuck 6 can hold the firing frame 2f by other alternative means or manners such as sucking or magnetic absorbing.

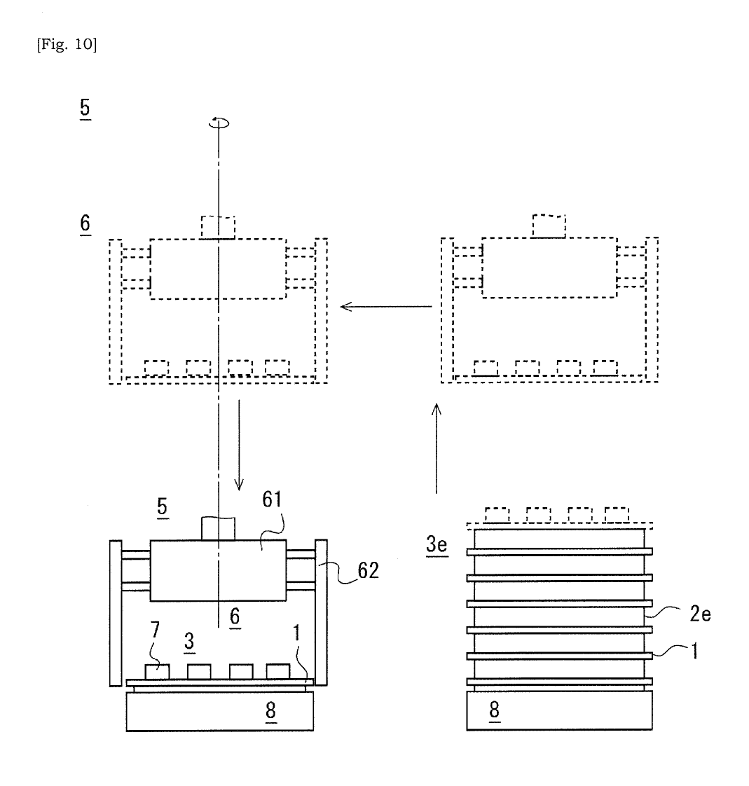

FIG. 10 illustrates that, based on operation of a transferring mechanism 5 at the second location P2, the shelf plate 1 is retrieved from the debindering shelf 3e having passed the debindering kiln 9 to build a new accommodating shelf 3, i.e. a new firing shelf 3f. At the second location P2, based on operation of the transferring mechanism 5, the shelf plate 1 is retrieved from the debindering shelf 3e having passed the debindering kiln 9 and is transferred to a location where a firing shelf 3f is built.

FIG. 11 illustrates that, based on operation of a transferring mechanism 5 at the third location P3, a firing frame 2f is retrieved from a stack of firing frames 2f to build a new firing shelf 3f. At the third location P3, based on operation of a transferring mechanism 5, the firing frame 2f is retrieved from the stack of firing frames 2f and plated on to a shelf plate 1 on which the debindered ceramic bodies 7 are placed.

At one or both locations of the fourth location P4 and the third location P3, rotation of the frame may be performed based on operation of the transferring mechanism. Rotational angle of the frame 2 at the third location P3 or the fourth location P4 is equal to or less than 180° or equal to or less than 90° or 90° in some cases. Total value of rotational angle of the frame 2 at the fourth location P4 and rotational angle of the frame 2 at the third location P3 is equal to or less than 180° in some cases. A magnitude of deformation of the frame 2 in accordance with increase of the number of times the frame 2 passes through the firing kiln 4 would be reduced, and thus facilitating longer lifetime of the frame 2. In some cases, the frame 2 has N corners (N indicates a natural number equal to or greater than 2) or N-corners polygon, and the rotational angle of the frame 2 is 360°/N.

In some cases, a transferring mechanism that retrieves a debindering frame 2e from the debindering shelf 3e and transfers it to a location where a firing shelf 3f is built and a transferring mechanism that retrieves a firing frame 2f from a stack of firing frames 2f and transfers it to a location where a firing shelf 3f is built are the same transferring mechanism. Accordingly, reduction of cost of production facilities would be facilitated.

In some cases, the transferring mechanism 5 rotates the firing frame 2f by a predefined constant angle while transferring the firing frame 2f. The firing frame 2f will be rotated about a rotational axis that matches the vertical direction in accordance with increase of the number of times the firing frame 2f passes through the firing kiln 4. The rotational position of the firing frame 2f when passing through the firing kiln 4 at m times (m indicates natural number equal to or greater than 2) is different from a rotational position of the firing frame 2f when passing through the firing kiln 4 at m−1 times, by an angle that matches a rotational angle of the firing frame 2f by the transferring mechanism 5. In some cases, the firing frame 2f is shaped like a rectangle, and the firing frame 2f retrieved from a firing shelf 3f is rotated by 90° while being transferred by the transferring mechanism 5. Therefore, the rotational position of the firing frame 2f when passing through the firing kiln 4 at m times (m indicates natural number equal to or greater than 2) is different by 90° from a rotational position of the firing frame 2f when passing through the firing kiln 4 at m−1 times.

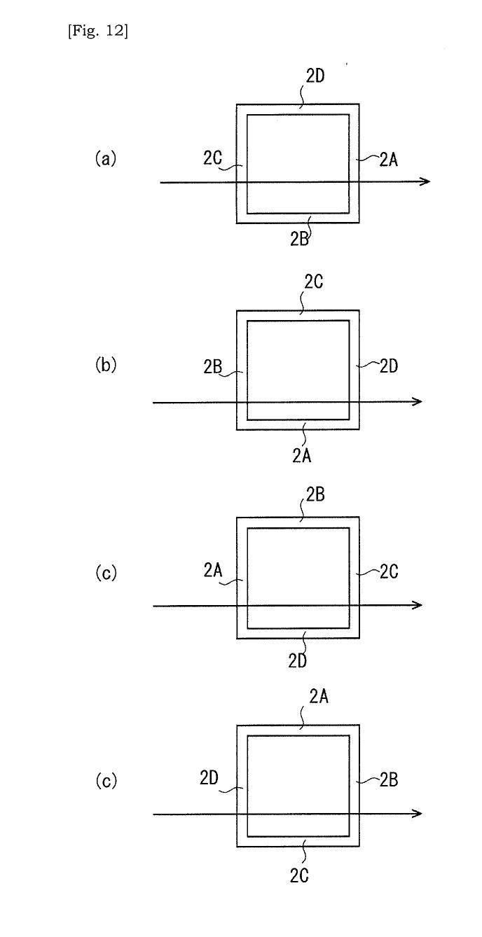

FIG. 12 schematically illustrates that, when looking at one firing frame 2f, the rotational position of the firing frame 2f when passing through the firing kiln 4 changes in accordance with increase of the number of times the firing frame 2f passes through the firing kiln 4. In some cases including FIG. 12, the firing frame 2f is square-shaped. The firing frame 2f has four corners, and has four portions 2A-2D of the circumferential wall 26 which extend in four different directions. At the stage of 1^{st} firing of FIG. 12(a), the portion 2A of the circumferential wall 26 faces downward in the moving direction of the firing frame 2f indicated by an arrow, and the portion 2C of the circumferential wall 26 faces upstream in the moving direction of the firing frame 2f. At the stage of 2^{nd} firing of FIG. 12(b), the portion 2A of the circumferential wall 26 faces rightward in left-right direction perpendicular to the moving direction of the firing frame 2f in accordance with 90° rotation of the firing frame 2f, and the portion 2C of the circumferential wall 26 faces leftward in the left-right direction. At the stage of 3^{rd} firing of FIG. 12(c), the portion 2A of the circumferential wall 26 faces upstream in the moving direction of the firing frame 2f indicated by an arrow and the portion 2C of the circumferential wall 26 faces downstream in the moving direction of the firing frame 2f. At the stage of the 4th firing of FIG. 12(d), the portion 2A of the circumferential wall 26 faces leftward in the left-right direction in accordance with 90° rotation of the firing frame 2f, and the portion 2C of the circumferential wall 26 faces rightward in the left-right direction. The rotational position of the firing frame 2f at the stage of 5^{th} firing would be identical to that shown in FIG. 12(a). Similarly for the following firings, the rotational position of the firing frame 2f when passing through the firing kiln 4 changes in accordance with rotation of the firing frame 2f. The firing frame 2f is rotated such that the rotational position of the firing frame 2f is changed when passing through the firing kiln 4, thereby facilitating that the deformation of the frame 2 caused in the past firing would be cancelled by the deformation of the frame 2 that would be caused in the following or future firing. Accordingly, a magnitude of deformation of the frame 2 in accordance with increase of the number of times the frame 2 passes through the firing kiln 4 would be lowered, and thus facilitating longer lifetime of the frame 2.

### Working Example

An accommodating shelf built from frames of alumina and shelf plates of silicon carbide passed through a firing kiln by total 6 times. In the working example, after passed through the firing kiln, the frame was rotated by 90° at the third location P3. In a comparative example, the frame was not rotated by 90° at the third location P3. In the working example, a first width of the frame was decreased by 0.36 mm compared with a first standard width. In contrast, in the comparative example, the first width was decreased by 0.71 mm compared with a first standard width. In the working example, a second width of the frame was decreased by 0.18 mm compared with a second standard width. In contrast, in the comparative example, the second width was increased by 0.32 mm compared with a second standard width. As such, it has been confirmed that a magnitude of deformation of the frame in the working example is reduced relative to the comparative example. It should be noted that, the first standard width of the frame was 372 mm, and the second standard width was 372 mm. The first standard width and the first width of the frame was a width of the frame in a direction parallel to the moving direction of the accommodating shelf within a firing kiln. The second standard width and the second width of the frame was a width of the frame in a direction perpendicular to the moving direction of the accommodating shelf within a firing kiln.

Based on the above teachings, a skilled person would be able to add various modifications to the respective embodiments.

What is claimed is:

1. A method of producing a ceramic fired body, comprising:
a step of passing a first accommodating shelf through a firing kiln, the first accommodating shelf including a stack of units of a shelf plate and a frame placed on the shelf plate, one or more ceramic bodies placed on the shelf plate being surrounded by the frame extending in a circumferential direction between the shelf plates;
a step of retrieving one or more frames from the first accommodating shelf which has passed through the firing kiln;
a step of using the one or more retrieved frames to build a second accommodating shelf for passing through the firing kiln; and
a step of rotating the retrieved frame such that a rotational position of the retrieved frame when the second accommodating shelf passes through the firing kiln is different from a rotational position of the retrieved frame when the first accommodating shelf passed through the firing kiln.

2. The method of producing a ceramic fired body according to claim 1, wherein the retrieved frame is rotated about a rotational axis that matches a vertical direction in accordance with increase of the number of times the retrieved frame passes through the firing kiln.

3. The method of producing a ceramic fired body according to claim 1, wherein the retrieved frame is rotated at a predefined constant angle.

4. The method of producing a ceramic fired body according to claim 1, wherein the frame includes silicon carbide (SiC) or alumina (Al₂ O₃) or mullite (3Al₂ O₃ 2SiO₂).

5. The method of producing a ceramic fired body according to claim 1, wherein the frame is square-shaped.

6. The method of producing a ceramic fired body according to claim 1, wherein the rotation of the retrieved frame is performed
when the frame is retrieved from the first accommodating shelf which has passed through the firing kiln; and/or
when the second accommodating shelf is built; and/or
when the frame is transferred from one location to another location.

7. The method of producing a ceramic fired body according to claim 1, wherein the rotation of the retrieved frame is performed based on operation of a transferring mechanism that transfers the frame.

8. The method of producing a ceramic fired body according to claim 7, wherein the transferring mechanism includes a chuck configured to hold the frame.

9. The method of producing a ceramic fired body according to claim 1, wherein the one or more ceramic bodies to be fired in the firing kiln includes one or more debindered ceramic bodies.

10. The method of producing a ceramic fired body according to claim 9, wherein said building a second accommodating shelf using one or more retrieved frames includes placing the retrieved frame onto the shelf plate on which the debindered ceramic bodies are placed.

11. The method of producing a ceramic fired body according to claim 1, wherein the rotation of the retrieved frame is caused by at least one of:
(i) rotation of the shelf plate on which the retrieved frame is placed;
(ii) rotation of the second accommodating shelf; and
(iii) rotation of the retrieved frame.

12. The method of producing a ceramic fired body according to claim 1, wherein the shelf plate is provided with at least one protrusion such that the position of the frame is restricted on the shelf plate.

13. The method of producing a ceramic fired body according to claim 1, wherein the ceramic body includes at least silicon carbide (SiC).

14. The method of producing a ceramic fired body according to claim 1, wherein the ceramic body has a lattice-like cell-wall defining a plurality of cells.

15. The method of producing a ceramic fired body according to claim 1, further comprising a step of firing the one or more ceramic bodies in the firing kiln under nonoxidative atmosphere.
